(19) United States
(12) Patent Application Publication
(10) Pub. No.: US 2012/0143641 A1
(43) Pub. Date: Jun. 7, 2012

(54) Systems and Methods for Computing Business Value

(76) Inventor: Patrick J. O'Brien, San Ramon, CA (US)

(21) Appl. No.: 13/311,385

(22) Filed: Dec. 5, 2011

Related U.S. Application Data
(60) Provisional application No. 61/458,920, filed on Dec. 6, 2010.

(51) Int. Cl. G06Q 10/00

(52) U.S. Cl. 705/7.11

(57) ABSTRACT

The present invention relates to systems and methods for computing business value, thereby enable interested parties to accurately and efficiently determine the value of a given solution to a stakeholder. The system collates solution attributes. The solution may include any goods or services that a vendor, or other supplier, is offering to a purchaser. The solution attributes include the cost of the solution, the areas of a business that the solution impacts and degree of improvement that the solution provides to key performance indicators that are relevant to the areas impacted. The system also provides community aggregated values for the key performance indicators and other metrics for the impacted areas. The system collates stakeholder specific information, including revenue for the stakeholder and key objectives.

### CROSS REFERENCE TO RELATED APPLICATION

This application claims priority to U.S. Provisional Application Ser. No. 61/458,920 filed on Dec. 6, 2010, entitled “System and Method for Value Selling or Buying”, which is hereby fully incorporated by reference.

### BACKGROUND

The present invention relates to systems and methods for the analysis of the value of a solution in the context of Business to Business (B2B) sales and purchasing. In some embodiments, such a system may be utilized by vendors to express their solution's value to a prospective buyer. In alternate embodiments, the buyer may utilize these systems and methods to make more informed purchasing decisions relating to the buyer's realizable value. Lastly, in yet other embodiments, vendors, buyers and potentially third parties may collaborate utilizing these systems and methods to ensure optimal sales and purchasing decisions are realized. Of note is that these unique systems and methods deliver powerful value assessments without requiring user expertise.

Today, businesses selling to large businesses often struggle to easily, credibly, and adequately discuss and describe the value, versus the features or benefits, of their offering to prospective clients. Likewise buyers face the same struggles of understanding the value of a prospective purchase. In particular these businesses are forced to start from scratch when building a Return on Investment (ROI) and Business Case. Many businesses find it difficult to easily share or collaborate around the inputs and outputs, and spend countless unnecessary hours hunting for difficult to find data points required for proper calculations.

Many solutions exist today for the creation of various value-selling tools, but they are prohibitively expensive and complex and do not address the key aspect of value selling: identifying the issues that matter to the prospect. Sales Reps struggle to identify the real issues affecting the large businesses they are selling to. This results in an ineffective and inefficient sales process that can lead sales people to move totally away from value based selling and the use of ROIs, which in turn directly undermines sales for that company. Buyers face a similar issue painting a value based picture within their organization for desired solutions. Ultimately, the lack of the necessary tools to properly analyze value results in lost sales, or lost opportunities.

It is therefore apparent that an urgent need exists for an improved business value computation tool for the facilitation of business-to-business selling and/or buying activities that enable collaboration and community sourced data, ease of use, and aggregated data to reduce complexity, and improve the generation of value analyses.

### SUMMARY

To achieve the foregoing and in accordance with the present invention, systems and methods for quantifying and aligning a business value is presented. Such systems and methods enable any interested party to accurately and efficiently determine the value of a given solution to a buyer, or other stakeholder. Such systems and methods may simplify the value calculations through question guided interfaces, and uniquely derived collaborative data for streamlining the value computation.

Computation of business value includes quantifying the value of a solution for a given purchaser, and unlike previous value calculations, aligning the solution to the goals and interests of the purchaser in order to generate a more meaningful value assessment. For the purposes of this disclosure, the terms “value”, “business value”, “value analysis”, and “value proposal/proposition” may be considered synonymous with an assessment that both quantifies and aligns the solution to the purchaser.

Likewise, in this disclosure, the phrase “computing business value” refers to the act of aligning the solution to the purchaser, and quantifying the value of the solution to that customer given the alignment.

In some embodiments of the systems and methods for computing a business value, the system is capable of collating solution attributes. The solution may include any goods or services that a vendor, or other supplier, is offering to a purchaser. The solution attributes, at a minimum include the cost of the solution, and the areas of a business that the solution impacts. Further, the solutions attributes includes the degree of improvement that the solution provides to key performance indicators that are relevant to the areas impacted.

The system also predicts prototypical values for the key performance Indicators for the impacted areas based upon collaborative, or community derived, data. In some embodiments, data is collected and stored from a number of users, based upon size and industry, and these values may be averaged in order to refine the prototypical value predictions.

Additionally, system is capable of collating stakeholder specific information, which may include revenue for the stakeholder, and one or more key objectives for the stakeholder. Additional information about the stakeholder that may be relevant includes industry of the stakeholder, employee number, number of customers, and potentially geographic location. Additional stakeholder information may be collected depending on the nature of the vendor's offering.

Next, the system may associate the improvements to key performance indicators with the key objectives, and compute the value using the solution attributes and the stakeholder specific information. This computation enables the stakeholder to perform analytical cost benefit analysis, where the business value includes a quantified return-on-investment (ROI) of the customer, a return on investment, and internal rate of return, and a graphical representation of some of these metrics. The system will also quantify and highlight the link between the customer's key business drivers and the specific benefits of the vendor (alignment). In some embodiments, interest rates may be factored into the calculation of business value.

In some cases the return on investment is calculated by solving:

$$Value = {\sum }_{j = 0}^{n} {C}_{j} \cdot {I}_{j} \cdot {Q}_{j}$$

where:

n=the total number of key performance indicators;

C=cost or revenue associated with the key performance indicator;

I=the improvement of the key performance indicator; and

Q=the quantity of the given key performance indicator.

Further, in some embodiments of the systems and methods, the means for generating customized templates is also provided. In these embodiments, a template customization toolset is provided to the stakeholder. The system collates a customized template and saves it for future stakeholders or potentially other users. The template may be populated by communal values, and may be presented to future stakeholders for filling out the missing data. The completed form may then be utilized to generate a value case as identified previously.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a logical block diagram of a framework for implementation of a value analysis system, in accordance with some embodiment;

FIG. 2 is a more detailed logical block diagram of the Business Value Computation System, in accordance with some embodiment;

FIG. 3A is an example flowchart for the process of computing business value, in accordance with some embodiment;

FIG. 3B is an example flowchart for the process of inputting solution information, in accordance with some embodiment;

FIG. 3C is an example flowchart for the process of inputting customer information, in accordance with some embodiment;

FIG. 4 is an example screenshot of the initial interface for the business value computation system, in accordance with some embodiment;

FIG. 5 is an example screenshot of the vendor information interface for the business value computation system, in accordance with some embodiment;

FIG. 6 is an example screenshot of the customer information interface for the business value computation system, in accordance with some embodiment;

FIGS. 7A to 7D are example screenshots of the improvement selection interface for the business value system, in accordance with some embodiment;

FIG. 8 is an example screenshot of the business driver selection interface for the business value computation system, in accordance with some embodiment;

FIGS. 9A and 9B are example screenshots of the results interface for the business value computation system, in accordance with some embodiment; and

FIG. 10 is an example flowchart for the process of computing business value with template selection, in accordance with some embodiment.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

The present invention relates to systems and methods for quickly and efficiently computing business value for a product or solution. This tool may leverage collaboration among users in order to facilitate the sale or purchase within a Business to Business (B2B) setting. These collaborations may include using community driven functionality and inputs. The present systems and methods are superior to current methods for demonstrating value by driving Sales Reps, or Buyers, to more effectively understand, and align, solutions to key issues with prospective customers. The systems and methods are easier to use because they require fewer direct inputs, no specific technical knowledge of some calculation system, and much less time to gather elusive data. The disclosed systems and methods are more accessible because they can be used “as is”, without the need for expensive consulting or professional services.

Computation of business value includes quantifying the value of a solution for a given purchaser, and unlike previous value calculations, aligning the solution to the goals and interests of the purchaser in order to generate a more meaningful value assessment. For the purposes of this disclosure, the terms “value”, “business value”, “value analysis”, and “value proposal/proposition” may be considered synonymous with an assessment that quantifies and/or aligns the solution to the purchaser.

Likewise, in this disclosure, the phrase “computing business value” refers to the act of aligning the solution to the purchaser's business drivers, and/or quantifying the value of the solution to that customer.

In some embodiments, the systems and methods for computing business value may be instrumental in facilitating a more expansive selling methodology, and assist the user to get management approvals for migrating to this system from key decision maker(s). This methodology is aimed at complex, expensive sales, and focuses on the “Steps” after the initial lead and/or contact: 1) Lead, 2) Preparation, 3) Assessment, 4) Value, and 5) Deal. With a lead in hand a sales representative should go into Prepare mode, then as they engage the prospect, they should be in Assess mode. After adequate assessment they should focus on Value, and should stay there until the prospect brings them to a conversation about a Deal.

The tools provided herein, enable sales representatives and/or buyers to more efficiently fulfill the “value” stage of the above methodology. As demonstrating value is crucial to the consummation of a purchase, the system and methods described here can significantly impact the speed and quality of negotiations. Note that within this disclosure the term “stakeholder” may be generally employed in order to refer to customers, sellers, and other third parties to a purchasing decision. For example, stakeholders may include manufacturers, distributors, service providers, insurers, investors, auditors, vendors, and the like.

The system for computing business value may be an independently hosted system, a locally hosted system, or may include a plug-in module to other enterprise software in order to augment their operation. Many companies produce enterprise software for managing negotiations, resource management, and finance utilizations. Oracle®, SAP®, Cisco®, WorkDay.com®, and SalesForce.com® are all examples of enterprise software manufacturers that could incorporate the system for computing business value into their existing enterprise software.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

### I. Overview

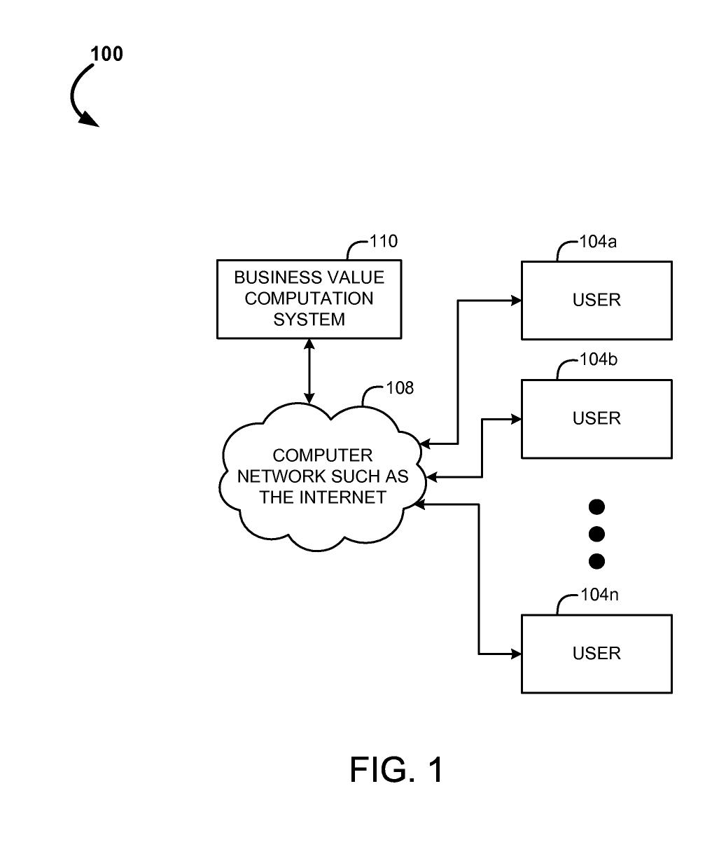

To facilitate the discussion, FIG. 1 is a logical block diagram of a framework 100 for implementation of a Business Value Computation System 110, in accordance with some embodiment. As previously noted, systems and methods described herein provide for calculating, and demonstrating, the value, such as through the calculation of return on investment, of a business solution, product, or technology purchase (all of which will be referred to hereafter as a “solution”) using community driven functionality and inputs. The Business Value Computation System 110 may be accessible to one or more Users 104a to 104n via a computer network 108 using any of the many available web browsers (e.g., Internet Explorer, Mozilla Firefox, Google Chrome, Safari, etc.) via any available device (e.g., computer, mobile phone, TV, etc.). In some embodiments, the computer network 108 may include any large scale WAN, including the internet, intranets, a corporate or other private network, or a collection of coupled local networks.

Value can be described as the monetary calculation associated with eliminating specific pains points, or driving key goals or initiatives within a business, for which that particular business cares about. Community driven functionality means multiple Users 104a to 104n can define, and collaborate on, the areas of impact, departments, groups, solutions, delivery methods, risks, initiatives, formulas and any other data point used to calculate values.

The Users 104a to 104n may be located within the same organization, or may represent many people from a wide variety of organizations spanning a number of industries. As the Business Value Computation System 110 gains some measure of its utility from its collaborative features, having a plurality of Users 104a to 104n can be a large asset. The community may be represented, in some embodiments, by the population of other Users 104a to 104n of the Business Value Computation System, or participants in a forum. Further, Users may get benefit from other users, not directly linked or working on the same business value assessment, in the form of more accurate benchmarks, community generated templates and data points or other information usable across multiple value calculations.

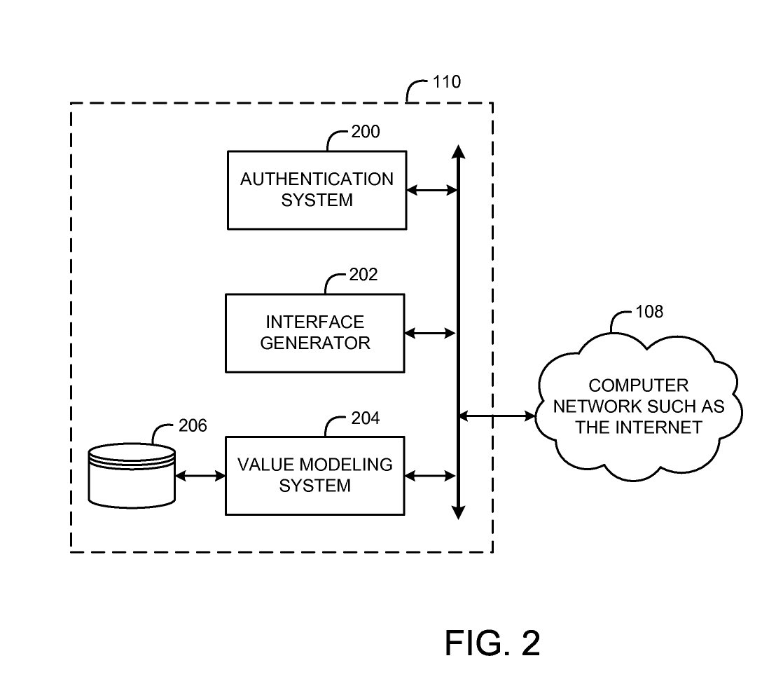

FIG. 2 is a more detailed logical block diagram of the Business Value Computation System 110, in accordance with some embodiment. In some embodiments, these systems and methods may include computer software stored on memory being implemented using processors. Data may be stored on a networked server or on a user's system, or both. In this example embodiment, the Business Value Computation System 110 may include an Authentication system 200, an Interface Generator 202 and a Value Modeling System 204 coupled together. The Storage 206 may also have a Storage 206 accessible to save collaborative inputs supplied by the various Users 104a to 104n.

The Authentication system 200 enables the Business Value Computation System 110 to track and verify the identity of the Users 104a to 104n. In some embodiments, there is no need to characterize or track the Users 104a to 104n; however, in alternate embodiments, it may be desirable to limit or secure the sharing of certain information or data possibly through a premium subscription, or other identification requirement in order to maintain system integrity.

The Interface Generator 202 may be a web server capable of providing the Users 104a to 104n a graphical interface for interacting with the Business Value Computation System as well as generating user and case specific graphical results 110, 912. Based on simple to answer questions, answered by the user via an interactive online questionnaire, user will be presented with a customized interface, and the option to use community provided data, or data the user inputs themselves. Data may travel from user to server or server to user, or user to user.

The Storage 206 stores, manipulates, and retrieves data utilizing various functions. Specific instances will be available for individual Users 104a to 104n to save, access, and share their templates, and individual inputs. Collaborative functionality allows multiple Users 104a to 104n to access and manipulate data within the same instance of the program, and gives Users 104a to 104n, depending on their type (primary user, invited participant, pro user, vendor, buyer, etc.) the ability to manage said collaboration.

For example, two different Users 104a to 104n may change or view the same piece of data. Preconfigured templates allow users to choose industries, types of solutions, areas of impact or other aspects specific to that solution, product, company, or user in order to perform the value calculation. The Business Value Computation System 110 also allows Users 104a to 104n to update, change, or otherwise edit provided templates for their own custom needs. These new templates will be savable, and possibly made available to the community. Community data aggregation will allow users to use data inputted by other users, or otherwise provided via server, and thus made available to multiple Users 104a to 104n.

Improvement percentage averages used in formulas may thus be continuously updated for specific solutions, and vendors, to be used at the discretion of other users. Where prudent, anonymity will be applied to community available data. Calculations occur within server, or on the user's system, or both, and are presented to Users 104a to 104n in multiple ways, including as a return on investment, total cost of ownership, NPV, IRR, Payback, and via a dashboard, and/or on a final results page. In this example embodiment, the Value Modeling System 204 provides the actual calculations using inputs provided from the Users 104a to 104n, as well as saved inputs (such as averaged industry percentages) located in the Storage 206.

Algorithms or mathematical formulas are used to perform calculations. The formulas used to calculate values are dependent on departments, groups, solution types, delivery methods, initiatives, KPIs or other factors the user selects; thus the calculations will be completely customizable and dynamic. Value will be calculated by taking the formulas associated with the selections by the user, taking community provided and user provided inputs for all key data points, and applying the solution's improvement percentages. Improvement averages may be an average taken from the community or inputted by the user for performing the calculations.

The value may be presented in a combination of views, such as by department, by initiative, or area of impact (e.g., revenue, opex, capex, etc.). Tagging of data and calculations within the program provide a mechanism for determining where and how calculations are displayed. A historical record of the output and calculations will be maintained on the server or user's system or both.

Note that alternate structures for the Business Value Computation System 110 and framework may also be utilized. For example, in some alternate embodiments, the Business Value Computation System 110 may be locally stored on one or more Users 104a to 104n systems and these local systems may query a centralized database where data aggregates are stored. Such a system enables the computation burden to be distributed across a number of machines rather than relying upon centralized servers to perform all calculations.

### II. Process for Computing Business Value

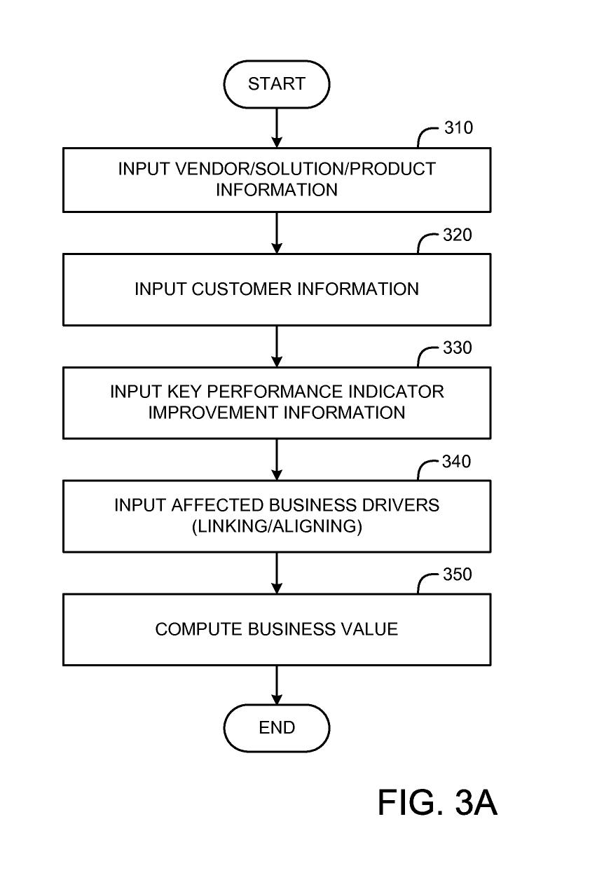

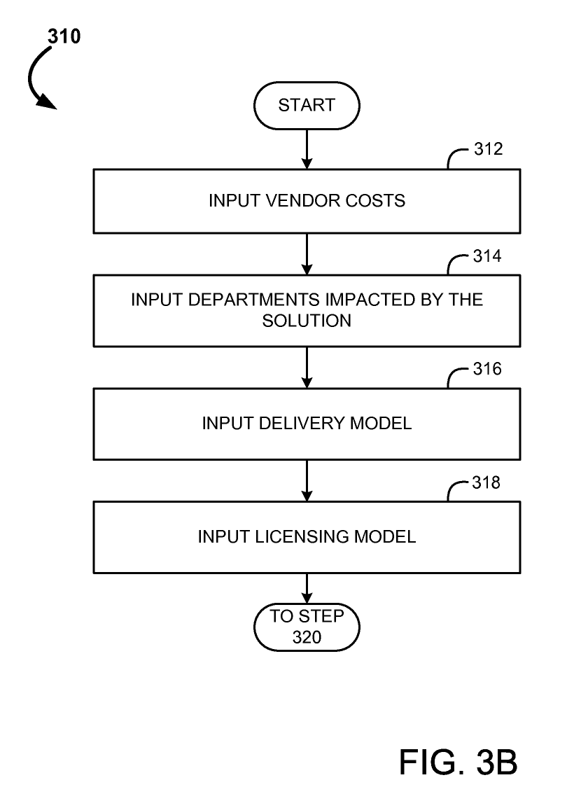

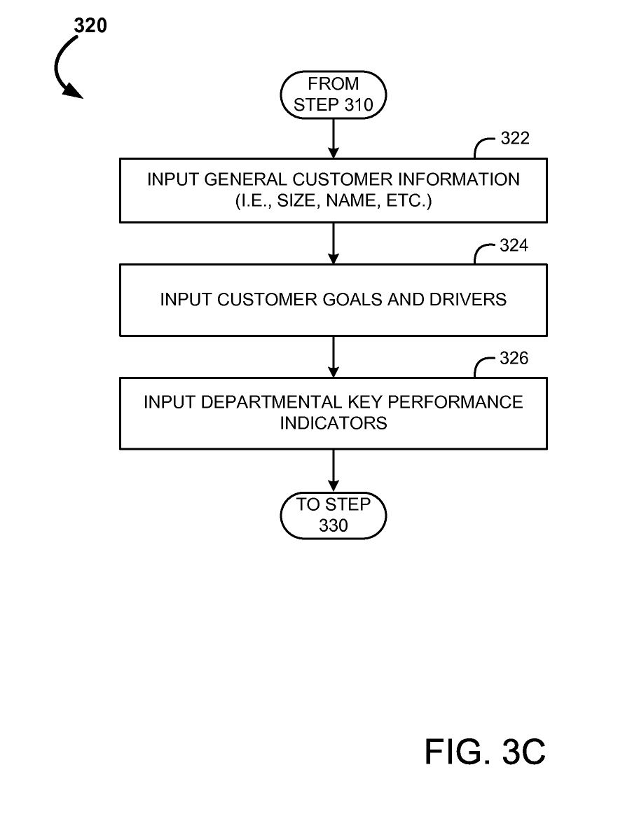

FIG. 3A is an example flowchart for the process of computing business value, in accordance with some embodiment. In this example flow diagram, the process begins by receiving an input of solution information (at 310). A more detailed illustration of this step may be seen in reference to FIG. 3B.

The input of vendor/product/solution information include the inputting of vendor costs (at 312), inputting of departments impacted by the solution (at 314), input of a delivery model (at 316), and inputting of a licensing model (at 318). Vendor costs may include up front fees, maintenance costs, implementation costs, ongoing subscription/royalty fees, and the like. Departments impacted by the solution may include human resources, IT, legal, sales, research, and other well established business departments. Delivery model refers to the means for delivering the product/solution to the customer once purchased. Lastly, the licensing or payment model refers to the method of paying for the solution/product/service. The received solution information may be utilized to later limit user selections, thereby providing a dynamic user experience that further simplifies the computation of business value. For example, if the solution is consisting entirely of hardware, the delivery options may be limited accordingly.

Returning to FIG. 3A, after receiving the solution information, the system may receive the input relating to customer information (at 320). A more detailed illustration of this step may be seen in reference to FIG. 3C.

The input of customer information includes inputting general customer data (at 322), customer goals and drivers (at 324), and inputting of the customer's specific values for Key Performance Indicators (KPI), or the use of—at the users discretion—community generated data, for the departments effected by the solution (at 326). General customer information may include basic information such as the customer's name/identifier, size, gross revenue, number of consumers, etc. The customer business drivers include areas that the customer has particular interest in, is focused on, and that the vendor can impact.

In some embodiments, the Key Performance Indicators may be auto populated depending upon industry averages and aggregated user inputs. In other embodiments, industry indices, trade association data, or other aggregated point data sources may be utilized to auto-generate key performance indicators predictions. It may be possible to combine the data from multiple sources, such as through a weighted average, in order to predict a “true” key performance indicator value that accurately reflects the customer's business. This may be referred to as predicting “prototypical values” for key performance indicators. These KPIs may also be adjusted by the individual user. The KPIs displayed to the user may be based upon the earlier input of which department is impacted by the solution.

In some embodiments, a limited number of KPIs for each department are utilized by the models of this system. Limiting the number of KPIs per department may be necessary due to the increase in system complexity the more KPIs that are introduced; perceived simplicity and usability of the system by a user; and the fact that these performance indicators are intended to embody the “key” or most important for the department.

Returning to FIG. 3A, after receiving the customer information, the system may receive input for key performance indicator improvements generated as a result of the solution (at 330). The inputting of performance indicator improvements may appear relatively innocuous; however, this portion of the process defines what kind of impact the solution has on the customer's bottom line, and may be considered an important part of data the user inputs, as these values are entirely solution dependent.

Next, the system may receive an input for the business drivers that are affected by the solution (at 340). This procedure may also be referred to as “linking” the KPIs that are improved by the solution to the customer drivers previously identified.

The linking of the KPI improvements to the customer's drivers may be utilized to perform value calculations in order to compute the business value (at 350). The business value may be expressed in terms of Return on Investment (ROI) over a selected time period, cost versus return graphs, repayment schedule, etc.

Generally, the calculation of the value to the customer for the solution may take the general form of the following equation:

$$Value = {\sum }_{j = 0}^{n} {C}_{j} \cdot {I}_{j} \cdot {Q}_{j}$$

where:

n=the total number of KPIs;

C=cost or revenue associated with the key performance indicator;

I=the improvement of the KPI; and

Q=the quantity of the given KPI measure.

In this example equation, the operator between the quantity, cost/revenue, and improvement may be a multiplier, or similar function.

The quantity of the given KPI may vary depending upon the KPI. For example, for improvement to server utilization the quantity may be the number of servers multiplied by the utilization rate per server. These values may, in turn, be estimated based upon industry type, number of employees, number of customers, and the revenue of the company.

### III. Examples

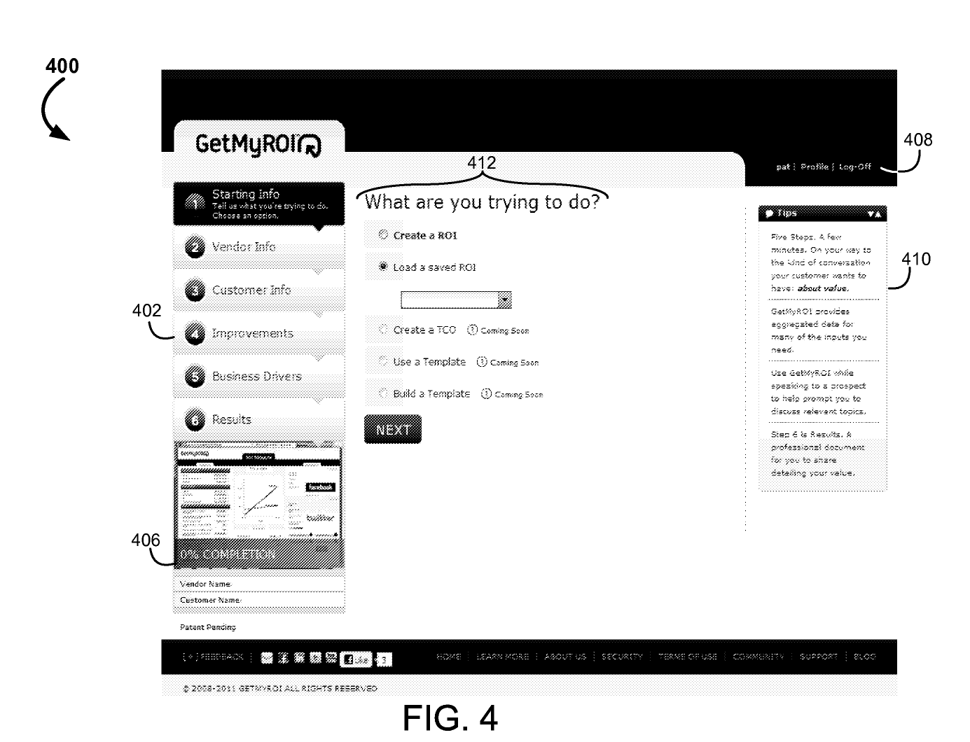

FIG. 4 is an example screenshot of the initial interface 400 for the business value computation system, in accordance with some embodiment. In this example screenshot, a side navigation bar 402 provides the user an identification of where in the process the user currently is, and allows the user to navigate to another step in the process. A completion indicator 406 illustrates how far along the user is to completing the process. Further, a profile and login hyperlink 408 enables the user to access a personal profile, saved business value assessments, and saved data.

On the initial interface, the user is provided a series of initial selections 412 to enable a more directed user experience. In some embodiments, these selections may include performing a Return on Investment (ROI) or other business value computations, load an existing ROI analysis, creating a Total Cost to Ownership (TCO) analysis and utilization of templates for the business value computation. Utilization of templates will be discussed in greater below. For now, however, particular attention will be directed at the ROI analysis. The analysis is named for future identification, or an existing ROI may be loaded, as is illustrated in this example.

A series of tips 410 specific to this interface are provided to help direct the user. On this page, the tips are directed to the basic functionality of the business value computation tool. Tips may also be dedicated to a specific vendor or solution or template, where desired.

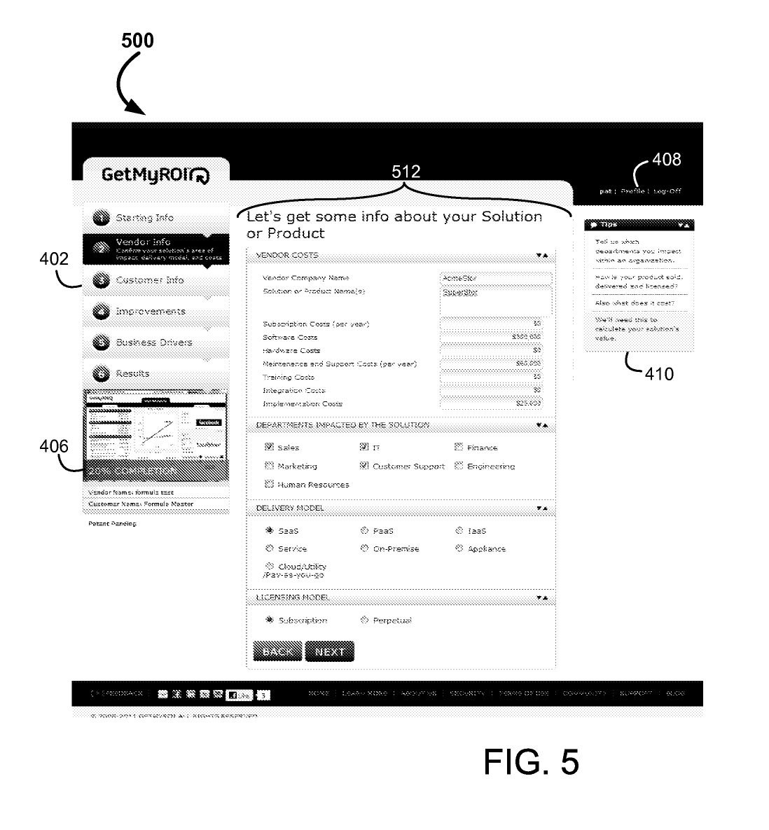

Next, in relation to FIG. 5, an example screenshot of the vendor information interface 500 is illustrated. On this interface, a series of questions 512 directed to the solution are made. These may include questions asking the name of the vendor, the name of the solution/product/service, and costs for the product. Costs may include subscription costs, software and hardware costs, maintenance and support, training costs, integration costs and implementation costs, and services for example.

Additionally, the departments impacted by the solution need to be identified by the user, as well as delivery and licensing models. In this specific example, a software package is being analyzed. The software package has a subscription cost of sixty thousand dollars, and up-front costs totaling $325,000. This example software package is identified as impacting the Sales, IT, and Customer Support departments of a company, is delivered via SaaS (Software as a Service), and is a subscription based licensing model.

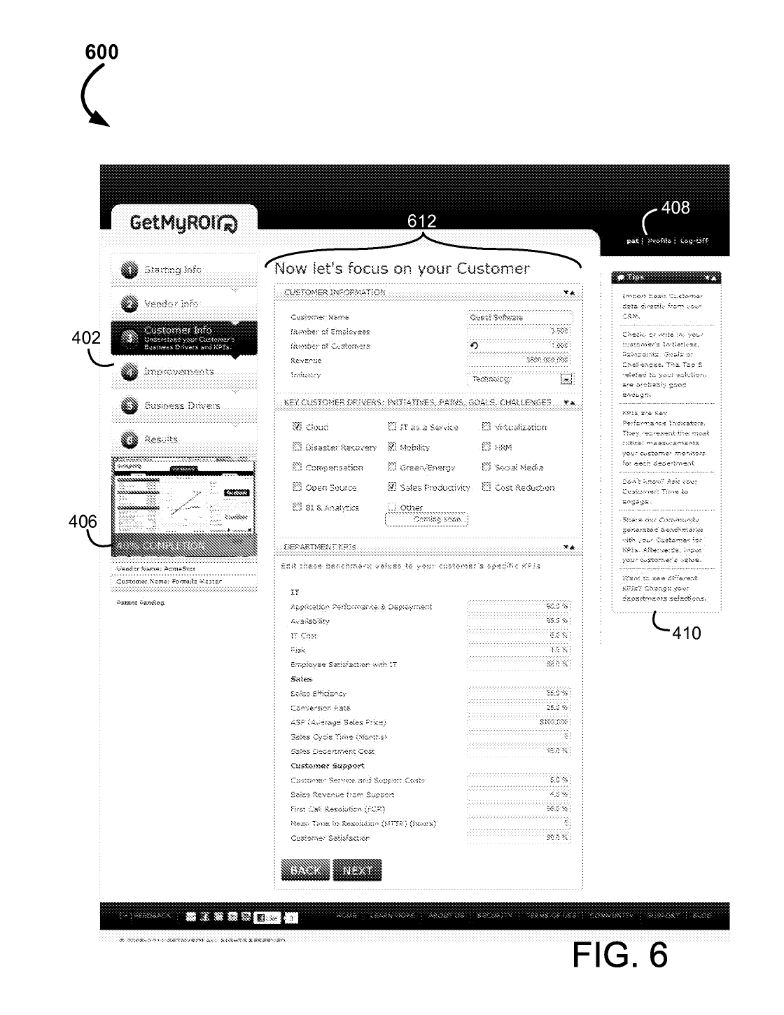

Next, in relation to FIG. 6, an example screenshot of the customer information interface 600 is illustrated. Here, a series of questions and inputs 612 are presented to the user relating to the customer that the solution impacts. This may include a customer's name, their size, revenue, and industry type. Industry type may be utilized to auto-populate downstream values with industry averages, in some embodiments. Additionally, in some embodiments, the customer name may be utilized to compare the user's inputs to those of other users' inputs regarding the customer.

The user also selects the major goals and drivers for the company, and Key Performance Indicators (KPIs) are displayed. KPIs may be auto-populated for the departments identified on the previous interface screen using aggregated inputs and industry standards.

In the current example, the user has indicated that the solution would apply to a customer of 3,500 employees which grosses eight hundred million dollars in revenue. This company is in the technology industry. For a technology company, sales productivity, cloud computing, and mobility are often key goals and priorities. For the sales department, IT, and customer support, a listing of KPIs is auto-populated, in this example.

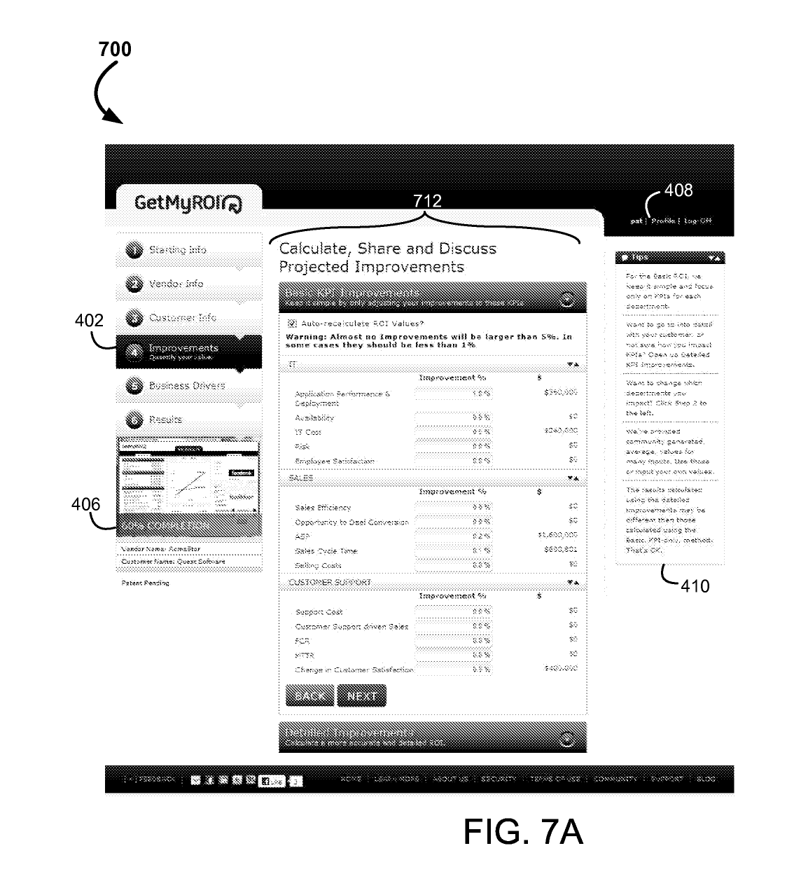

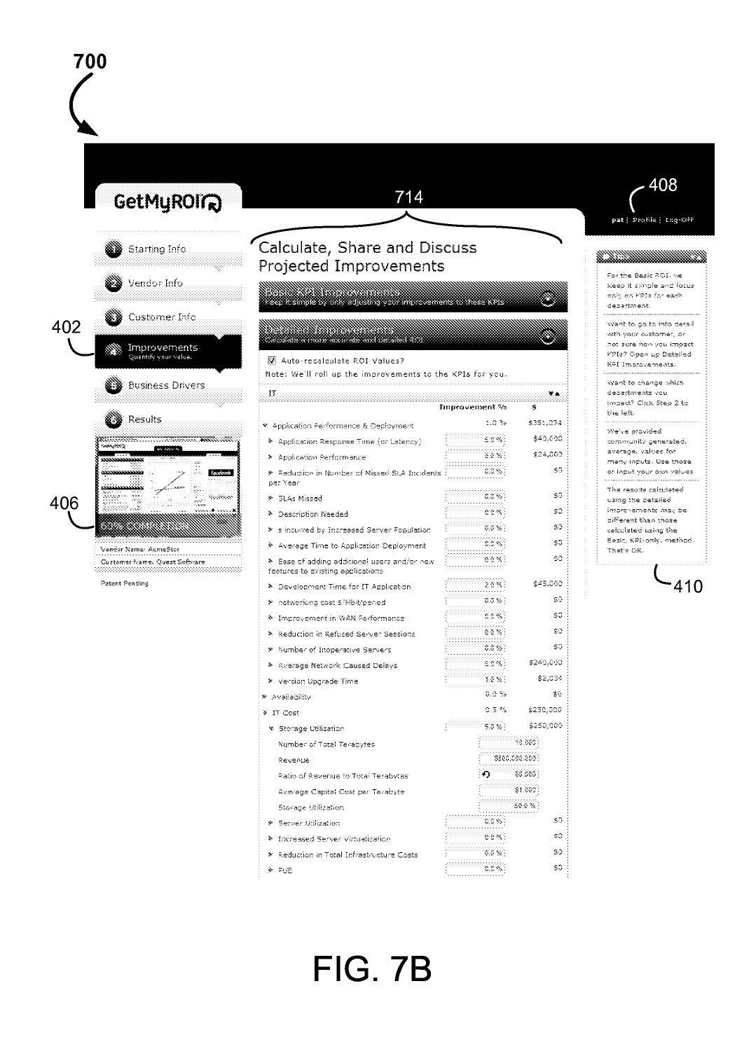

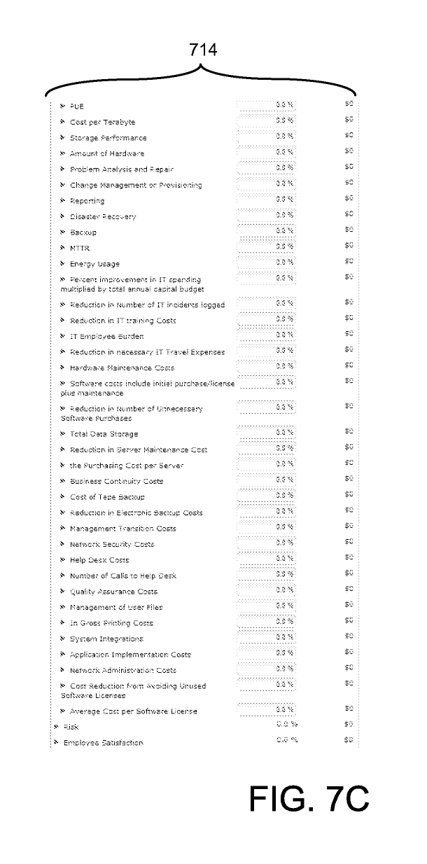

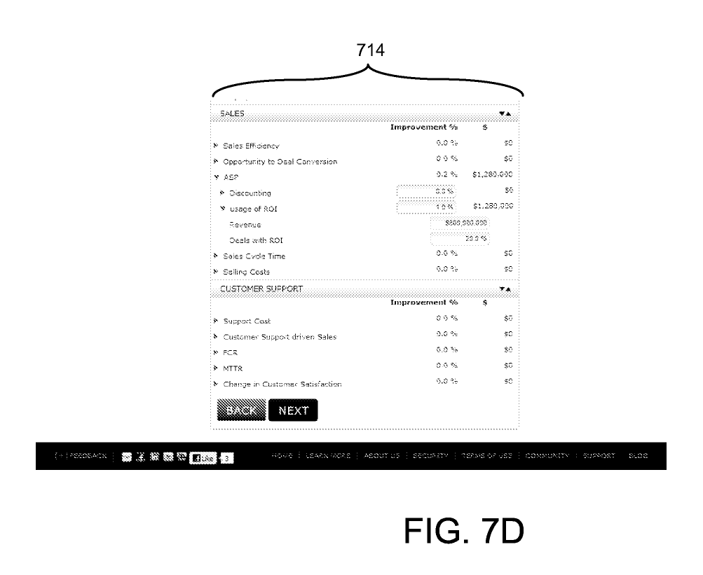

Next, in relation to FIGS. 7A and 7B are example screenshots where the improvement selection interface 700 is illustrated. At these screens, the user is asked to identify and quantify percentage improvements provided by the solution to the KPIs of the departments identified as being impacted by the solution. These KPI improvement values impact the value the solution provides to the customer, in conjunction with the customer's size, revenue and goals.

For the present example, the user indicated that the solution provides a 1% improvement in Application performance and development, a 0.5% improvement in IT cost, a 0.2% improvement in ASP, a 0.1% improvement in Sales Cycle Time, and a 0.5% improvement in customer satisfaction. The program automatically generates a value for these improvements, which is displayed to the user.

In addition to the “simplified” KPI improvement model 712 utilized in the present example at FIG. 7A, a more detailed KPI improvement model 714 may be utilized in FIGS. 7B to 7D. The detailed KPI improvement model 714 may be significantly more granular in structure, and enables a user to refine where the improvements are applied.

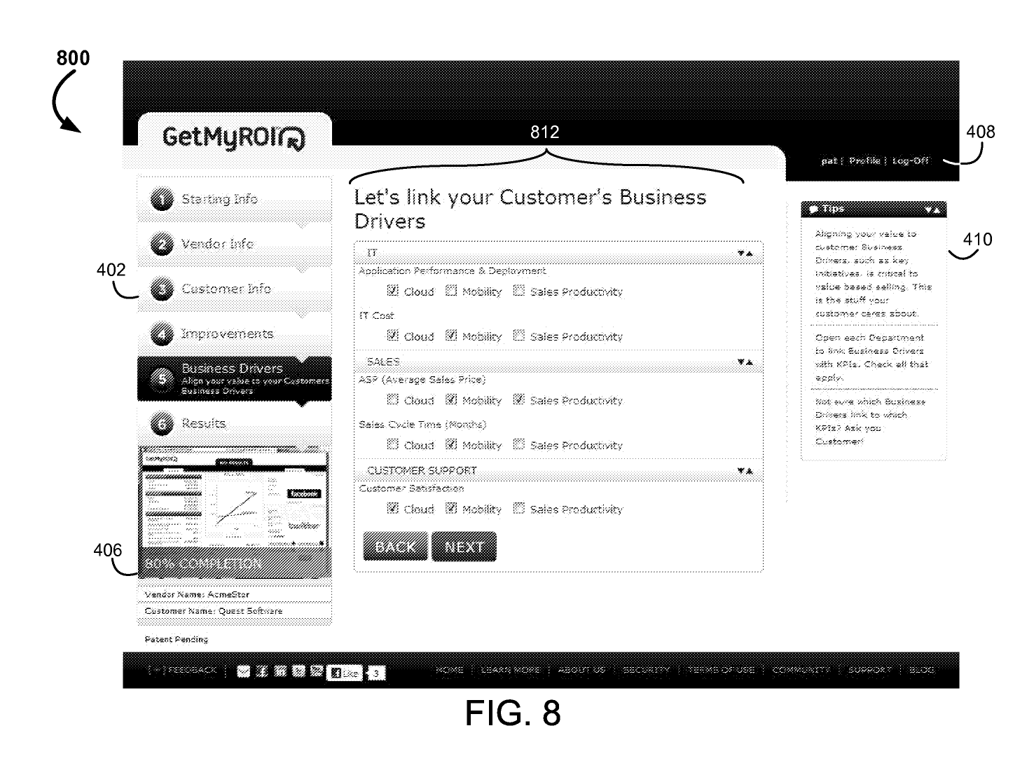

Next, in relation to FIG. 8 an example screenshot of the business driver selection 800 is illustrated. In this example, the user is provided the listing of the KPI improvements and options of which customer goals these improvements may be applied to (linked) 812. These may be listed by department.

In this present example, the KPI improvements were to cloud for both Application performance and IT costs, mobility and sales productivity to ASP, mobility to sales cycle time, and cloud and mobility to customer support. For customers with more diverse goals, and more departments being impacted by the solution, a greater number of linking permutations become available. The division of calculated value can be made in any number of ways. For this case the system is automatically dividing the benefit equally among checked Business Drivers.

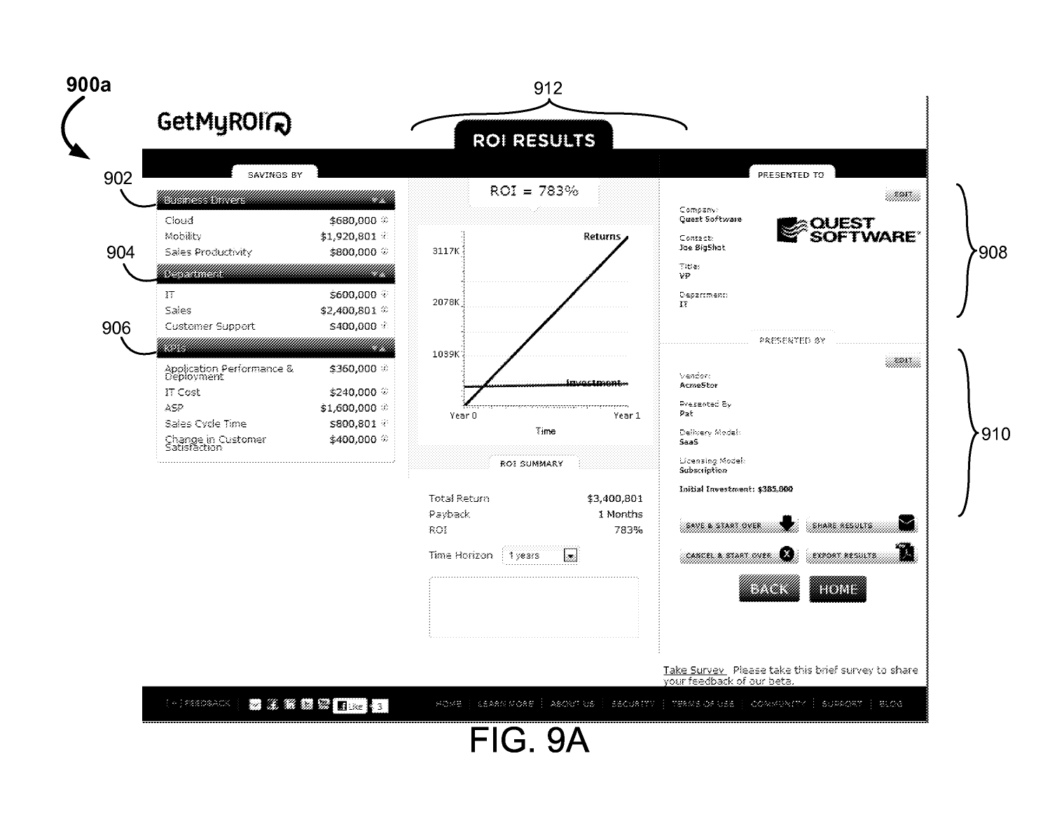

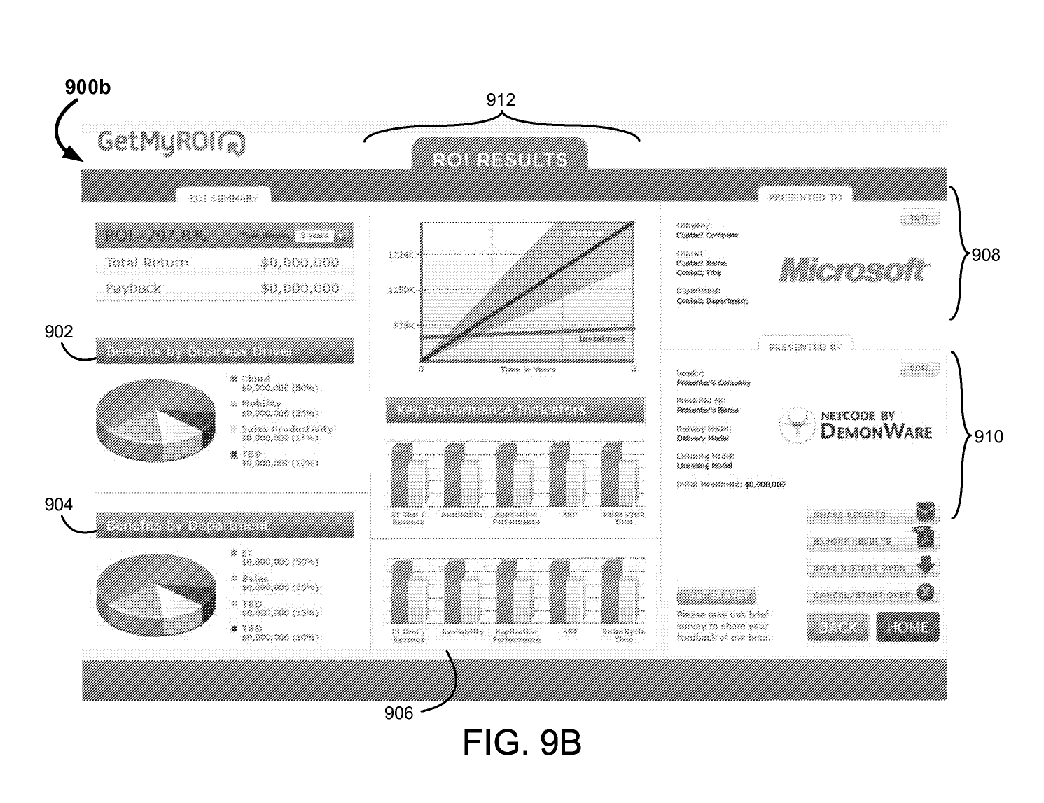

Lastly, FIGS. 9A and 9B are example screenshots of the results interface 900. In these examples, savings by business drivers 902, department 904 and KPIs 906 are illustrated. Multiple KPIs are identified as being relevant to this example solution, and the savings are attributed to each of these KPIs accordingly.

FIGS. 9A and 9B are alternative screenshots for the results page. Generally, the information presented in these alternate screenshots is comparable, however the manner of information presentation is more graphical in FIG. 9B and more utilitarian in FIG. 9A. For example, FIG. 9B utilizes pie charts and histograms for displaying savings by business drivers 902, department 904 and KPIs 906.

Additionally, in these interfaces, a ROI value, graph and summary 912 are illustrated. For this example solution, in FIG. 9A, the ROI over a 1 year period is calculated as being 783%, with a payback period of 1 month. Users can modify the time horizon to better understand the ROI in both the near term and long term.

Lastly, the interface provides a summary of who the analysis is presented to 908, and who it is presented by 910, including uploaded logos, where desired. The summary may be exported or shared using a number of desired downstream programs such as document imaging software or spreadsheet software.

In addition to merely sharing the results of the business value computation, the user may also determine other users who may have access to view or even edit the business value computation. In this way a user can provide customers, or other parties, chances to review all the community provided data and decide to accept it, or manually change it, or possibly share that instance within their respective organization. This includes data for things such as the burden cost of a support rep, average length of a support call, field service revenue per rep, etc. Thus both parties involved are leveraging the power of the community directly within the analysis tool, and collaborating in real time over what data to use for each input: community generated, user inputted, or calculated.

### IV. Template Utilization

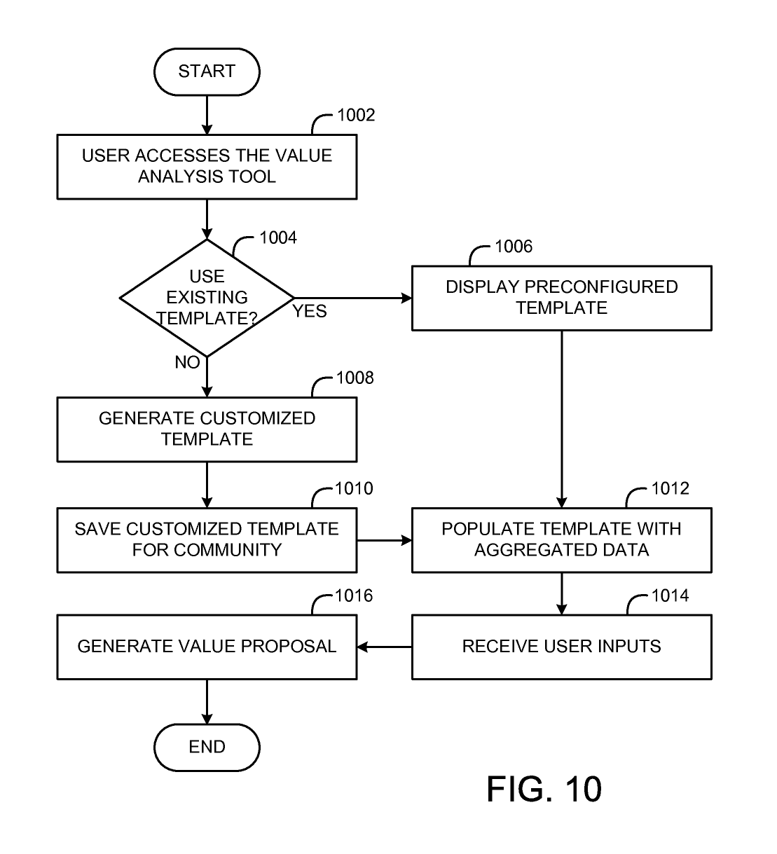

As previously noted, in some embodiments, the user may be prompted to decide whether to utilize an existing template or generate a new template for the business value computation. Existing templates may have been uploaded by prior users, or may be generated by other interested parties. FIG. 10 is an example flowchart for the process of computing business value with template selection, in accordance with some embodiment.

In this example process, the user accesses the Business Value Computation System (at 1002) and a decision is made (at 1004) over whether to use an existing template, or to generate a new template. Where an existing template is used, the process proceeds to where a preconfigured template is displayed to the user (at 1006). Otherwise, a customized template can be generated by the user (at 1008). This customized template may then be saved for the community, select users, or remain private (at 1010).

Regardless of whether an existing template or customized template is utilized, the template may then be populated with aggregated data (at 1012) that has been collected from the industries and individual users. Then user inputs are received (at 1014). User inputs may additionally update the preloaded aggregated values. The user inputs may also be saved as part of the user aggregate data to further refine the aggregate data. Lastly, the value may be generated (at 1016) as largely discussed previously, in some embodiments.

In some embodiments, the template builder is allowed to choose which things to “turn on” for the subsequent users, as well as give the builder the option of pre-populating certain fields, so the subsequent end user doesn't have too.

In sum, the present invention provides systems and methods for the analysis of value for a sales opportunity, or purchase, in a business to business sales environment. Such systems and methods may leverage communally derived inputs and aggregated data in order to remove much of the guesswork often involved in the computation of business value. Further, by linking key improvements to the goals of the customer, a simplified analysis may be effectuated which closely models actual customer value for the particular solution.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for computing business value, useful in association with a business value computation system, the method comprising:
collating solution attributes for a potential stakeholder, wherein the solution attributes include solution cost, areas impacted, and improvements to key performance indicators;
collating a plurality of stakeholder specific information for the potential stakeholder, wherein the stakeholder specific information includes revenue for the stakeholder, and at least one key objective;
predicting prototypical values for key performance indicators of the areas impacted based upon solution attributes, wherein the predicting is relative to community values for the key performance indicators;
associating the improvements to key performance indicators with at least one key objective; and
computing a business value using the solution attributes and the plurality of stakeholder specific information to enable the stakeholder to perform analytical cost benefit analysis, wherein the business value includes a quantified return-on-investment (ROI) of the customer.

2. The method as recited in claim 1, wherein the potential stakeholder is one participant in a food chain.

3. The method as recited in claim 2, wherein the potential stakeholder may comprise one of a producer, service provider, distributor, partner, consumer, and marketer.

4. The method as recited in claim 1, wherein the stakeholder specific information further comprises number of employees, industry type, and number of customers.

5. The method as recited in claim 1, wherein the prototypical values for key performance indicators are generated from stored communal inputs.

6. The method as recited in claim 1, wherein the business value includes a return on investment calculation which includes a summation of cost or revenue of the key performance indicator multiplied by the improvement to the key performance indicator multiplied by the quantity of the key performance indicator, wherein the summation is across all key performance indicators.

7. The method as recited in claim 6, wherein the return on investment is calculated by solving:
$$Value = {\sum }_{j = 0}^{n} {C}_{j} \cdot {I}_{j} \cdot {Q}_{j}$$
where:
n=the total number of key performance indicators;
C=cost or revenue associated with the key performance indicator;
I=the improvement of the key performance indicator; and
Q=the quantity of the given key performance indicator.

8. The method as recited in claim 6, wherein the business value includes generating a graph of solution costs and return on investment.

9. The method as recited in claim 1, further comprising displaying a customized interface to the user, wherein the interface is updated in response to the areas impacted.

10. The method as recited in claim 9, further comprising displaying a series of questions to the stakeholder via the interface to solve a value model.

11. The method as recited in claim 1, wherein generating the business value further includes calculating an internal rate of return.

12. The method as recited in claim 1, wherein generating the business value further includes adjusting for interest rates.

13. The method as recited in claim 1, wherein computing business value includes aligning the solution to the at least one key objective.

14. The method as recited in claim 1, wherein computing business value includes quantifying the business value of the solution to the stakeholder.

15. The method as recited in claim 1, wherein associating the improvements to key performance indicators with at least one key objective includes aligning the solution to the at least one key objective.

16. A method for generating a business value, useful in association with a business value system, the method comprising:
providing a template customization toolset to a stakeholder;
collating a customized template;
saving the customized template for future stakeholders;
populating the customized template with aggregated stakeholder data;
collating stakeholder inputs for values of the customized template in order to complete it; and
calculating a business value using the completed customized template.

17. The method as recited in claim 16, further comprising saving the stakeholder inputs and updating the aggregated stakeholder data using the saved stakeholder inputs.

18. The method as recited in claim 16, wherein the stakeholder inputs are received from more than one stakeholder.

19. A computerized dashboard for a business value computation system, comprising:
fields for receiving solution information for a potential customer;
fields for receiving a plurality of customer specific information for the potential customer;
fields for updating community provided values for key performance indicators, wherein the values are based upon inputted solution information, and wherein the predictions are relative to community values for the key performance indicators;
fields for receiving improvement measures to the key performance indicators, relative to the predicted prototypical values;
fields for receiving linking information for the customer, wherein the linking information relates the key performance indicators to at least one of a plurality of key business drivers; and
an interface for displaying a business value computed using the received information, wherein the business value includes a return-on-investment (ROI) of the customer.

20. The computerized dashboard of claim 19, wherein the fields for receiving solution information further comprises:
a field for receiving vendor costs; and
fields for receiving departments impacted by the solution.

21. The computerized dashboard of claim 19, wherein the fields for receiving customer information further comprises at least one of:
a field for receiving customer employee size;
a field for receiving customer revenue;
a field for receiving customer industry; and
fields for receiving customer key drivers.

22. The computerized dashboard of claim 20, further comprising an interface for displaying the key performance indicators determined based upon the selected departments impacted by the solution.

23. The computerized dashboard of claim 22, wherein the prototypical values for key performance indicators are generated from stored communal inputs.
